(19) United States
(12) Patent Application Publication
(10) Pub. No.: US 2022/0333414 A1
(43) Pub. Date: Oct. 20, 2022

(54) DOOR TOP SLIDING CHILD SAFETY LOCK

(71) Applicant: Predictable Solutions, LLC, Double Oak, TX (US)

(72) Inventor: John J. Smith, III, Double Oak, TX (US)

(21) Appl. No.: 17/230,797

(22) Filed: Apr. 14, 2021

(51) Int. Cl. E05C 1/04; E05C 1/00

(52) U.S. Cl. CPC E05C 1/04; E05C 1/006

(57) ABSTRACT

A door top child safety lock mechanism comprises a body slidably mountable on a door top and a channel and a locking plate. The channel includes a web extending between first and second flanges. The lock plate extends from the first flange and defines a locking slot extending along a slot axis. The lock plate further defines an interlock cut-out formed along a distal edge, relative to the first flange, of the locking slot, wherein first width W_{G} at the interlock cut-out is greater than second width W_{L} in a region that is laterally intervening between the interlock cut-out and the open end of the locking slot. A peg is mountable to a door frame and configured to slide through the open end of the locking slot and between the proximal and distal edges of the locking slot.

### TECHNICAL FIELD

The present disclosure relates to door locks and latches intended for child safety, and in particular to locks and latches for mounting on a residential door top. In one embodiment, a door top sliding lock provides increased resistance to opening due to shaking of the door.

### BACKGROUND

A variety of child-resistant door locks and latches are known for deterring small children from opening residential doors. Preferably a child-resistant door lock should be easy for an adult to operate but difficult or impossible for a child to operate.

One example of a child-resistant door lock is a door top sliding child lock mechanism sold by Predictable Solutions, LLC under the trademark GLIDELOK®. The GLIDELOK® door lock mechanism is suitable for use on most residential doors that swing on hinges. The GLIDELOK® door lock mechanism comprises a metal body for mounting on a door top and a metal peg for mounting on the door jamb or door frame. The GLIDELOK® body comprises a channel configured to slidably mount on a door top with the web of the channel resting on the door top and flanges of the channel hanging from the web on either side of the door. A lock plate extends horizontally from one flange of the channel, typically on the jamb side of the door, and defines a straight-sided U-shaped slot extending from a lateral edge and running parallel to the face of the door. The GLIDELOK® peg is rigidly mounted to the door jamb or door frame such that, when the GLIDELOK® body is positioned on the door top, the body can slide along the door top between a locked position, wherein the peg is disposed within the U-shaped slot thereby preventing the door from moving away from the peg (i.e., effectively locking the door), and an unlocked position, wherein the peg is disposed outside the U-shaped slot thereby allowing the door to move away from the peg (i.e., effectively unlocking the door). The GLIDELOK® mechanism is thus very simple for an adult to operate from either side of the door by merely pushing the exposed flange to slide the body back and forth along the door top between the locked position and the unlocked position and vice-versa. A small child cannot operate the GLIDELOK® mechanism because they are not tall enough to reach the mechanism on the door top to slide it. The GLIDELOK® mechanism can be adapted for doors of exceptional height or adults of lesser stature by attaching extension rods to the flanges of the GLIDELOK® mechanism. The extension rods hang down along each side of the door to a height where the adult can reach them to slide the GLIDELOK® body while a small child cannot reach them.

The existing GLIDELOK® mechanism is a simple and effective child-resistant lock; however, under some unusual circumstances the lock may be defeated (i.e., inadvertently unlocked) by repeated pushing, striking or shaking of the door. It is believed that sometimes pushing against a door locked with the GLIDELOK® mechanism causes the peg to exert a small lateral force against the lock plate on the door top due to the slight angle present between the door frame and the partially opened door (i.e., it has moved in a slight arc around the hinges). The lateral force may inadvertently move the lock plate a small distance. Normally, such small movement would be inconsequential. However, with repeated pushing, shaking or striking of the locked door, the succession of small lateral movements may progressively move (i.e., “walk”) the lock plate across the door top until the peg disengages from the U-shaped slot. At this point, the GLIDELOK® would no longer prevent the door from opening. In other cases, the lateral walking of the lock plate may be the cumulative effect of successive random movements of the lock plate caused by shaking the door against the peg rather than from uniform lateral forces. But the end result may be the same, i.e., the lock plate walks, i.e., moves laterally, until the peg disengages from the U-shaped slot, and the door can then be opened.

A need therefore exists, for an improved sliding door top lock that is resistant to unintended movement caused by repeated shaking or striking of the door, while remaining simple to install and operate by adults.

### SUMMARY

In one aspect, a door top sliding child safety lock mechanism is disclosed for mounting on a door assembly comprising a door hingedly connected to a door frame. The safety lock mechanism comprises a body slidably mountable on a door top of a door, the body including a channel section and a locking plate. The channel section includes a web extending between a first flange and a second flange, the second flange is disposed parallel to the first flange. The lock plate extends perpendicularly from an outer face of the first flange and defines a locking slot extending between an open end disposed along a lateral edge of the lock plate to a closed end along a slot axis running parallel to the flanges. The lock plate further defines an interlock cut-out formed along a distal edge, relative to the first flange, of the locking slot, wherein a first width W_{G} measured perpendicular to the slot axis at the interlock cut-out is greater than a second width W_{L}. measured perpendicular to the slot axis in a region of the lock plate that is laterally intervening between the interlock cut-out and the open end of the locking slot. A peg is mountable to a door frame and configured to slide through the open end of the locking slot and between the proximal and distal edges of the locking slot.

In one embodiment, the interlock cut-out comprises an arcuate notch formed along the distal edge of the locking slot.

In another embodiment, the interlock cut-out comprises a rectangular notch formed along the distal edge of the locking slot.

In still another embodiment, the interlock cut-out comprises a rectangular notch formed along the distal edge of the locking slot and a leading incline portion disposed towards the open end of the locking slot.

In yet another embodiment, the lock plate further comprises an anti-walk feature formed along the distal edge of the locking slot. The anti-walk feature is a profile that biases the lock plate laterally towards the open end of the locking slot when pushed against the peg.

In a further embodiment, the anti-walk feature is a portion of the interlock cut-out.

In a still further embodiment, the anti-walk feature is separate from the interlock cut-out.

In another aspect, a safety lock mechanism is disclosed, comprising a body slidably mountable on a door top of a door assembly comprising a door hingedly connected to a door frame, the door being rotatable relative to the door frame about a hinge axis, the door top extending between a frame-side face of the door and an open-side face of the door. The body comprises a channel section including a web extending between a first flange and a second flange, the second flange being disposed parallel to the first flange. The channel section is configured so that the web can rest on the door top with the first flange depending from the web adjacent to the frame-side face of the door and the second flange depending from the web adjacent to the open-side face of the door. The frame-side and open side faces of the door define a lateral direction parallel thereto. A lock plate extends perpendicularly from an outer face of the first flange, the lock plate configured to extend horizontally away from the frame-side face of the door when the body is mounted on the door top. The lock plate defines a locking slot extending between an open end disposed along a first lateral edge of the lock plate to a closed end along a slot axis parallel to the frame-side face of the door. The lock plate further defines an interlock cut-out formed along a distal edge, relative to the first flange, of the locking slot, wherein a first width W_{G} measured perpendicular to the slot axis at the interlock cut-out is greater than a second width W_{L} measured perpendicular to the slot axis in a region of the lock plate that is laterally intervening between the interlock cut-out and the open end of the locking slot. A peg is configured to slide into the locking slot and fixedly mountable to a portion of the door frame adjacent to a frame-side edge of the door top to extend downward from the door frame. When the body is positioned on the door top of a door adjacent the door frame and the peg is fixedly mounted on the door frame with the peg aligned with the slot axis, the lock mechanism can move between an unlocked configuration and a locked configuration by sliding the body laterally on the door relative to the peg. When the lock mechanism is in the unlocked configuration, the peg is disposed outside the locking slot of the lock plate, thereby allowing the body to rotate around the hinge axis away from the peg and allowing the door to rotate away from the door frame. When the lock mechanism is in the locked configuration, the peg is disposed within the locking slot of the lock plate, thereby restricting the body from rotating around the hinge axis away from the peg and restricting the door from rotating away from the door frame. The lock mechanism can move between the locked configuration and an interlocked configuration by rotating the body relative to the peg around the hinge axis. When the lock mechanism is in the locked configuration, the peg is not disposed within the interlock cut-out of the lock plate, thus allowing the body to slide laterally far enough to release the peg from the locking slot. When the lock mechanism is in the interlocked configuration, the peg is at least partially disposed within the interlock cut-out, thereby restricting the body from sliding laterally far enough to release the peg from the locking slot.

In one embodiment, the lock mechanism cannot move directly from the unlocked configuration into the interlocked configuration.

In another embodiment, the lock plate further comprises an anti-walk feature formed along the distal edge of the locking slot, the anti-walk feature being a profile that biases the lock plate laterally towards the open end of the locking slot when pushed against the peg.

In yet another aspect, a door top sliding child safety lock mechanism comprises a body slidably mountable on a top of a door, the body including a channel section and a locking plate. The channel section includes a web extending between a first flange and a second flange, the second flange being disposed parallel to the first flange. The lock plate extends perpendicularly from an outer face of the first flange and defines a locking slot extending between an open end disposed along a lateral edge of the lock plate to a closed end along a slot axis running parallel to the flanges. A peg is mountable to a door frame and configured to slide through the open end of the locking slot and between the proximal and distal edges of the locking slot. The lock plate further defines an anti-walk feature formed along one side of the locking slot, the anti-walk feature being a profile that biases the lock plate laterally towards the open end of the locking slot when pushed against the peg.

In one embodiment, the anti-walk feature comprises a notch formed along a distal edge of the locking slot relative to the first flange, and the distal edge of the notch slopes towards the first flange viewed in a direction towards the open end of the locking slot.

In another embodiment, the lock plate further defines an interlock cut-out, the interlock cut-out being a profile formed along a distal edge of the locking slot. A first width W_{G} measured perpendicular to the slot axis at the interlock cut-out is greater than a second width W_{L} measured perpendicular to the slot axis in a region of the lock plate that is laterally intervening between the interlock cut-out and the open end of the locking slot.

In yet another embodiment, the interlock cut-out comprises an arcuate notch formed along the distal edge of the locking slot.

In still another embodiment, the interlock cut-out comprises a rectangular notch formed along the distal edge of the locking slot.

In a further embodiment, the interlock cut-out comprises a rectangular notch formed along the distal edge of the locking slot and a leading incline portion disposed towards the open end of the locking slot.

### BRIEF DESCRIPTION OF THE DRAWINGS

For a more complete understanding, reference is now made to the following description taken in conjunction with the accompanying Drawings in which:

FIG. 1 is a bottom perspective view of a door top sliding child safety lock mechanism in accordance with one aspect;

FIG. 2 shows the lock mechanism of FIG. 1 mounted to a door assembly with the door frame shown in dotted line and the door omitted;

FIG. 3 shows the lock mechanism of FIG. 1 mounted to a door assembly with the door shown in dotted line and the door frame omitted; and

FIG. 4A shows a partial bottom view of the lock mechanism in an unlocked configuration with the door closed;

FIG. 4B shows the lock mechanism of FIG. 4A in the unlocked configuration with the door open;

FIG. 5A shows the lock mechanism of FIG. 4A in a locked configuration with the door closed;

FIG. 5B shows the lock mechanism of FIG. 4A in the interlocked configuration with the door ajar and the peg biased against the lock plate and the anti-walk feature engaging the peg to prevent the lock mechanism from unlocking; and

FIGS. 6A-6C show partial views of a lock plate and peg for the lock mechanism with different interlock cut-out and anti-walk features in accordance with different embodiments.

### DETAILED DESCRIPTION

Referring now to the drawings, wherein like reference numbers are used herein to designate like elements throughout, the various views and embodiments of a door top sliding child safety lock are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

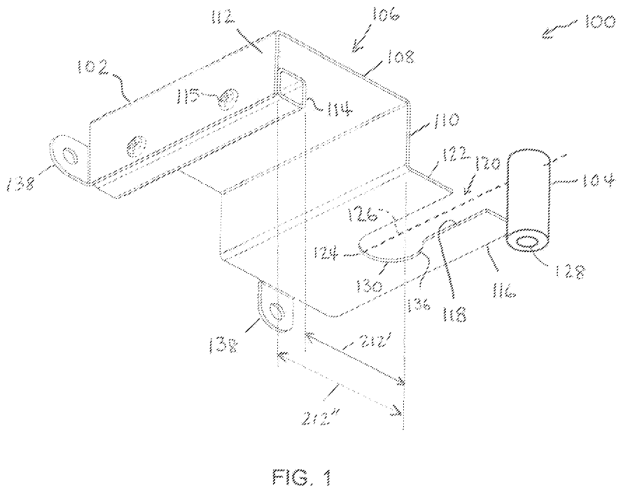

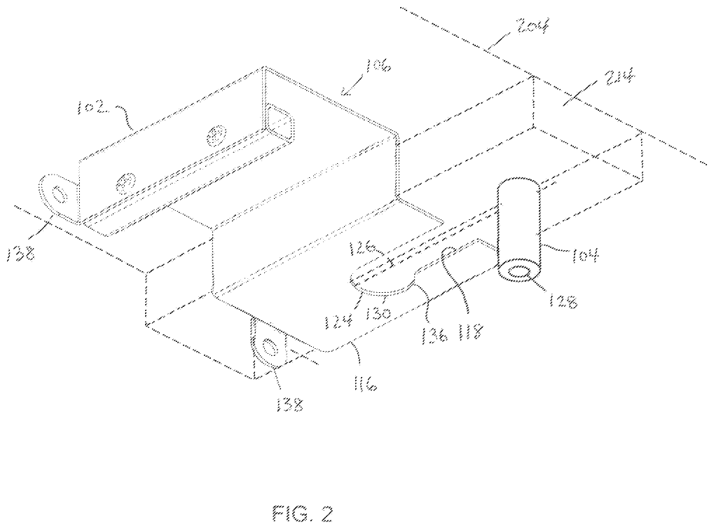

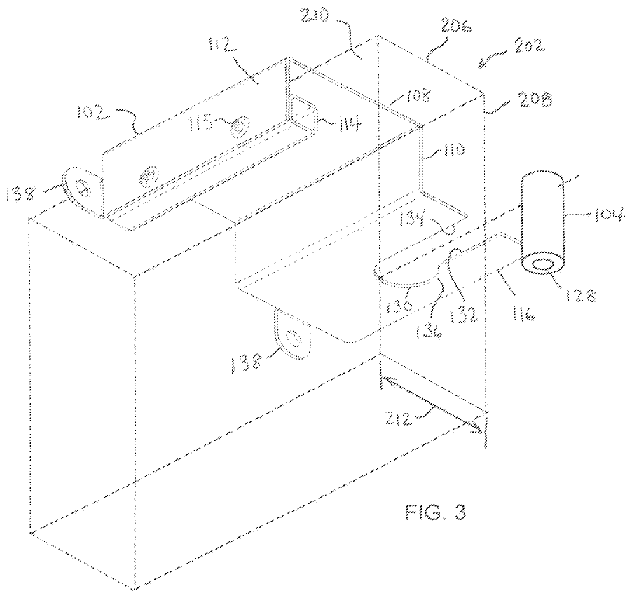

Referring to FIGS. 1-3, a door top sliding child safety lock mechanism 100 is illustrated suitable for mounting on a door assembly 200 including a door 202 (FIG. 3) and a door frame 204 (FIG. 2). The door 202 of the door assembly 200 is typically connected to the door frame 204 by side-mounted hinges (not shown) such that the door can rotate about a vertical hinge axis for opening and closing. For purposes of better illustration, in FIG. 2 the door frame 204 is shown in dotted line and the door 202 is omitted, and in FIG. 3 the door 202 is shown in dotted line and the door frame 204 is omitted. The lock mechanism 100 includes a body 102 and a peg 104, with the body being adapted for slidable mounting on the door 202 and the peg being adapted for fixed mounting on the door frame 204.

Referring in particular to FIG. 1, the body 102 of the lock mechanism 100 comprises a channel section 106 including a web 108 extending between a first flange 110 and a second flange 112. In most embodiments, the channel section 106 is configured as a C-channel, and the flanges 110, 112 extend perpendicularly from the web 108 and parallel to one another. As best seen in FIG. 3, the channel section 106 is configured so that the web 108 can rest on a door top 206 of the door 202 with the first flange 110 depending from the web adjacent to the frame-side face 208 of the door and the second flange 112 depending from the web adjacent to the open-side face 210 of the door. With the web 108 resting on the door top 206 and the flanges 110, 112 lying along the respective door faces 208 and 210, the body 102 can slide laterally along the door top while being constrained to lateral movement along the door top by the flanges. Thus, the body 102 is slidably mountable to the door top 206 of the door 202 without the need for fasteners or other attachment devices. In some embodiments, the body 102 further includes a removable spacer 114 connected to the inside face of one of the flanges 110, 112. The spacer 114 changes the effective thickness of one of the flanges 110, 112, thus changing the spacing between the flanges and allowing the body 102 to be used on doors 202 of different door widths (denoted by arrow 212). For example, the spacer 114 can remain attached for mounting the body 102 on a door of first width 212′ and can be removed for mounting the body on a door of second width 212″. In the embodiment of FIG. 1, the spacer 114 is removably attached to the second flange 112 by removable fasteners 115, e.g., screws. In other embodiments, the spacer 114 can be removably attached to the flange 110, 112 with other known types of fasteners, with magnets, or with fastening materials including, but not limited to, hook and loop material and adhesive.

The body 102 of the lock mechanism 100 further includes a lock plate 116 extending perpendicularly from an outer face of the first flange 110. As best seen in FIG. 3, the lock plate 116 extends horizontally away from the frame-side face 208 of the door 202 when the body 102 is mounted on the door top 206. The lock plate 116 defines a laterally-oriented locking slot 118 extending laterally between an open end 120 disposed along a first lateral edge 122 of the lock plate to a closed end 124 along a slot axis 126 running parallel to the flange 110 and frame-side face 208 of the door 202.

Referring now in particular to FIG. 2, the peg 104 is configured for attachment to the door frame 204 adjacent to the top of the frame-side face 208 of the door 202 (i.e., when the door is closed) so that the peg extends downward from the door frame proximate to the body 102 positioned on the door. In the illustrated embodiment, the peg 104 defines a through-hole 128 that can accept a long screw (not shown) for fastening the peg to the door jamb 214 (i.e., the portion of the door frame 204 that the door 202 stops against) in the desired position. In other embodiments, a different type of fastener can be used instead of a screw for attaching the peg 104 to the door frame 204 or door jamb 214. In still other embodiments, the peg 104 itself can be configured with an integral fastener for attaching the peg to the door frame 204 or door jamb 214. For example, the peg 104 can be configured with an integral spike portion that can be driven (i.e., like a nail) into the door frame/door jamb or an integral threaded portion that can screw into the door frame/door jamb.

The lock plate 116 of the body 102 is further configured to define an interlock cut-out 130 formed on the distal edge 132 of the locking slot 118. The distal edge 132 is the laterally-oriented edge of the locking slot 118 farthest from the first flange 110, whereas the laterally-oriented edge closest to the first flange is denoted as the proximal edge 134. The interlock cut-out 130 is a profile enlarging the width of the locking slot 118 (measured perpendicular to the slot axis 126) in a region of the locking plate 116 that is laterally spaced apart from the open end 120. In other words, between the interlock cut-out 130 and the slot open end 120, there is always portion of the locking slot 118 of narrower width than the interlock cut-out.

The interlock cut-out 130 does not contact the peg 104 during normal operation (i.e., lateral sliding) of the body 102 for locking and unlocking the lock mechanism 100 with the door 202 closed adjacent the door jamb 214. However, when the door 202 is moved ajar (i.e., slightly open in the circumferential direction around the door hinges) with the lock mechanism 100 in the locked configuration, the peg 104 moves into the interlock cut-out 130 and the lock mechanism moves from the locked configuration to the interlocked configuration. The difference between the locked configuration and the interlocked configuration of the lock mechanism 100 is very distinct: When the lock mechanism 100 is in the locked configuration, the peg 104 mechanically blocks rotational movement of the body 102 (i.e., around the hinge axis) but the peg does not mechanically block lateral movement of the body (i.e., sliding on the door 202) into the unlocked position, and thus the body is held in the locked position only by friction between the body and the door and peg. In contrast, when the lock mechanism 100 is in the interlocked configuration, the peg 104 mechanically blocks both rotation movement of the body 102 and lateral movement of the body into the unlocked position because of mechanical interference between the edge of the interlock cut-out 130 and the peg. Thus, when in the locked configuration, the body 102 can slide into the unlocked position if enough lateral force is applied to overcome friction, whereas in the interlocked configuration, the body will not slide into the unlocked position regardless of the lateral force applied because the peg is mechanically trapped within the interlock cut-out 130.

In the embodiment of FIGS. 1-3, the interlock cut-out 130 has the profile of a semicircular notch cut into the distal edge 132 of the locking slot 118 and sized to accommodate a portion of the peg 104 moving thereinto. In other embodiments, the interlock cut-out 130 may have the profile of a square, rectangle or triangular notch cut into the distal edge 132 sized to accommodate a portion of the peg 104 moving thereinto.

The lock plate 116 of the body 102 may be further configured to define an anti-walk feature 136 provided along one side of the locking slot 118. The anti-walk feature 136 does not contact the peg 104 during normal (i.e., sliding) motion for locking and unlocking of the lock mechanism with the door 202 closed adjacent the door jamb 214. However, when the closed door 202 is moved ajar, as when shaken or pushed when the lock mechanism 100 is engaged, the anti-walk feature 136 can contact the peg 104. The anti-walk feature 136 biases the lock plate 116 laterally towards the open end 120 of the locking slot 118 (i.e., the biasing force on the locking plate is in the direction of the open end) each time the peg 104 contacts the anti-walk feature. Thus, if the door 202 is pushed or shaken, the anti-walk feature 136 can push the lock plate 116 in the direction of the open end 120 each time the peg 104 contacts the anti-walk feature. Movement of the lock plate 116 in the direction of the bias caused by the anti-walk feature 136 can prevent the peg (which is fixed to the door jamb 214) from leaving the open end 120 of the locking slot so that the peg stays engaged with the locking plate despite the pushing or shaking.

In the illustrated embodiment of FIGS. 1-3, the anti-walk feature 136 comprises a portion of semicircular notch 130 formed in the distal edge 132 at the closed end 124 of the locking slot 118. As previously described, the semicircular notch 130 in this embodiment comprises an interlock cut-out, but the right-hand portion (as viewed in FIGS. 1-3) of the notch also acts as the anti-walk feature 136 because of its inclination relative to the slot axis 126. Thus, in some embodiments, interlock cut-out 130 and the anti-walk feature 136 may be incorporated into a common element, whereas in other embodiments, the interlock cut-out and the anti-walk feature may be separate elements, or only one of the elements may be present.

The body 102 can further comprise hanger eyes 138 extending from the flanges 110, 112 and/or lock plate 116. The hanger eyes 138 provide holes on each side of the door for attachment of extension handles (not shown) that hang down to an adult-accessible level when the lock mechanism 100 is used on tall doors.

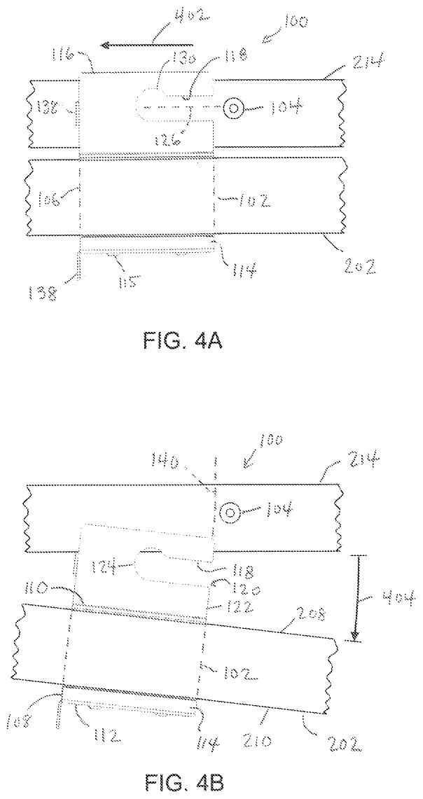

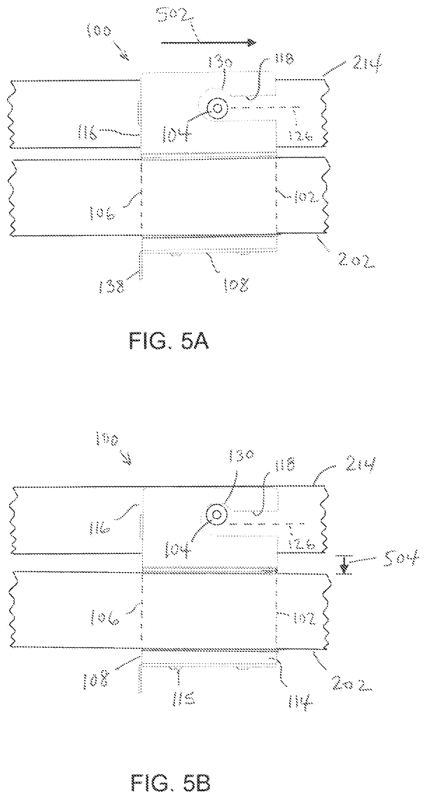

Referring now to FIGS. 4A-4B and 5A-5B, the lock mechanism 100 and its operation are shown as installed on a door assembly comprising a door 202 and door frame 204. The point of view is from below, looking upward. For purposes of illustration, only the door jamb 214 portion of the door frame 204 is shown. In these figures, the hinges (not shown) of the door assembly 200 joining the door 202 to the door frame 204, 214 are positioned to the left of the illustrated portions.

In FIG. 4A, the lock mechanism 100 is shown in the unlocked configuration and the door assembly 200 is closed. The body 102 of the lock mechanism 100 is placed on the top of the door 202, which is closed adjacent the door jamb 214. The web 108 of the body 102 rests on the door top with the first flange 110 hanging down from the web adjacent to the frame-side face 208 of the door 202 and the second flange 112 hanging down from the web adjacent to the open-side face 210 of the door (i.e., between the door top and the door jamb 214). The peg 104 is affixed to the door jamb 214 in a position so as to be aligned with the slot axis 126 of the locking slot 118 when the door 202 is closed adjacent the door jamb 214. However, the peg 104 is not positioned within the locking slot 118, so the body 102 is free to rotate away from the peg to open the door as shown in FIG. 4B.

FIG. 4B illustrates that, when the lock mechanism 100 is in the unlocked configuration, the body 102 can rotate away from the peg 104 around the hinge axis, and the moving edge of the body denoted by dashed line 140 will not be constrained by the peg, and thus the door 202 (upon which the body is mounted) can open by rotating away from the door jamb 214 (to which the peg is affixed) as denoted by movement arrow 404.

If the peg 104 is positioned within the locking slot 118 (e.g., FIG. 5A), then sliding the body 102 in the direction indicated by arrow 402 until the peg is not within the locking slot will move the lock mechanism 100 from the locked configuration into the unlocked configuration.

In FIG. 5A, the lock mechanism 100 is shown in the locked configuration and the door assembly 200 is closed. The body 102 of the lock mechanism 100 still rests on the top of the door 202, which is closed adjacent the door jamb 214. The peg 104 is still affixed to the door jamb 214. However, the body 202 has been moved along the top of the door 202 until the peg 104 is positioned within the locking slot 118 of the lock plate 116. When the lock mechanism 100 is in the locked configuration, the body 102 can rotate away from the peg 104 around the hinge axis only until the edge of the locking slot 118 hits the peg, typically less than 1 degree of rotation, and further rotation will be constrained (i.e., prevented) by the peg. Thus, the door 202 (upon which the body is mounted) is prevented from opening more than a trivial amount (i.e., less than a few degrees), and cannot open enough for a child to get through the doorway, and thus the door is effectively locked by the locking mechanism 100.

If the peg 104 is not positioned within the locking slot 118 (e.g., FIG. 4A), then sliding the body 102 in the direction indicated by arrow 502 until the peg is within the locking slot will move the lock mechanism 100 from the unlocked configuration into the locked configuration. It will be noted that when the lock mechanism 100 is in the locked configuration, the peg 104 constrains motion of the body 102 in the hinge rotation direction, but it does not constrain motion of the body in the lateral direction (i.e., with the peg moving towards the open end 120). Therefore, the door mechanism 100 can move directly between the locked configuration and unlocked configuration and vice versa by selectively sliding the body 102 along the door top without requiring rotational movement of the door 202.

Referring now to FIG. 5B, the lock mechanism 100 is shown in the interlocked configuration and the door assembly 200 is ajar, i.e., rotated a small amount (i.e., less than a few degrees) relative to the door jamb 214, until the peg 104 has moved at least partially into the interlock cut-out 130. The body 102 of the lock mechanism 100 still rests on the top of the door 202, and the peg is still affixed to the door jamb 214. Similar to the locked configuration, when the lock mechanism 100 is in the interlocked configuration, the body 102 can only rotate away from the peg 104 around the hinge axis until the edge of the interlock cut-out 130 hits the peg, typically less than 1 degree of rotation, and further rotation will be constrained (i.e., prevented) by the peg. Thus, the door 202 is prevented from opening more than a trivial amount and cannot open enough for a child to get through the doorway. Unlike the locked configuration, however, when the lock mechanism 100 is in the interlocked configuration, the peg 104 constrains motion of the body 102 in both the hinge rotation direction and in the lateral sliding direction because the peg cannot move past the reduction in width of the locking slot 118 between the interlock cut-out 130 and the open end 120 of the locking slot.

The locking mechanism 100 can move directly between the locked configuration and the interlocked configuration, and vice versa, by rotating the body 102 about the hinge axis to move the pin 104 into or out of, respectively, the interlock cut-out 130. However, the lock mechanism 100 cannot move directly between the interlocked configuration and unlocked configuration or vice versa. Rather, an intervening movement to the locked configuration is required to move the lock mechanism 100 from the interlocked configuration to the unlocked configuration.

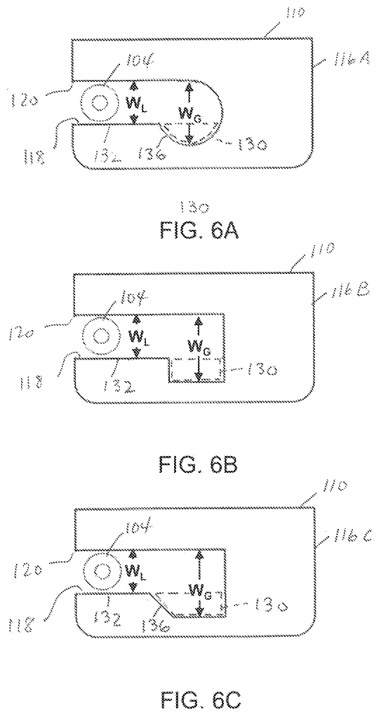

Referring now to FIGS. 6A-6C, there are illustrated various lock plates 116 in accordance with different embodiments. FIG. 6A illustrates a lock plate 116A having an interlock cut-out 130 (denoted by the dashed lines) with profile shaped as an arcuate curve. The width of the locking slot 118 at the interlock cut-out 130, denoted W_{G}, is greater that the width in a region of the lock plate 116A that is laterally spaced apart from the open end 120, denoted W_{L}. The locking plate 116A also includes an anti-walk feature 136 that comprises a sloped portion of the distal edge 132 that biases the lock plate to move in the direction of open end 120 when the peg 104 pushes against it.

FIG. 6B illustrates a lock plate 116B having an interlock cut-out 130 with profile shaped as a rectangular notch in the distal edge 132. The width of the locking slot 118 at the interlock cut-out 130, denoted W_{G}, is greater that the width in a region of the lock plate 116B that is laterally spaced apart from the open end 120, denoted W_{L}.

FIG. 6C illustrates a lock plate 116C having an interlock cut-out 130 with profile shaped as a rectangular notch with a leading incline in the distal edge 132. The width of the locking slot 118 at the interlock cut-out 130, denoted W_{G}, is greater that the width in a region of the lock plate 116C that is laterally spaced apart from the open end 120, denoted W_{L}. The locking plate 116C also includes an anti-walk feature 136 that comprises a leading incline portion of the distal edge 132 that biases the lock plate to move in the direction of open end 120 when the peg 104 pushes against it.

It will be appreciated by those skilled in the art having the benefit of this disclosure that this door top sliding child safety lock provides increased reliability while retaining ease of installation and operation. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A door top sliding child safety lock mechanism for mounting on a door assembly comprising a door hingedly connected to a door frame, the safety lock mechanism comprising:
a body slidably mountable on a door top of a door, the body including a channel section and a locking plate;
the channel section including a web extending between a first flange and a second flange, the second flange being disposed parallel to the first flange; and
the lock plate extending perpendicularly from an outer face of the first flange and defining a locking slot extending between an open end disposed along a lateral edge of the lock plate to a closed end along a slot axis running parallel to the flanges; and
wherein the lock plate further defines an interlock cut-out formed along a distal edge, relative to the first flange, of the locking slot, wherein a first width W_{G} measured perpendicular to the slot axis at the interlock cut-out is greater than a second width W_{L}. measured perpendicular to the slot axis in a region of the lock plate that is laterally intervening between the interlock cut-out and the open end of the locking slot; and
a peg mountable to a door frame and configured to slide through the open end of the locking slot and between the proximal and distal edges of the locking slot.

2. A door top sliding child safety lock mechanism in accordance with claim 1, wherein the interlock cut-out comprises an arcuate notch formed along the distal edge of the locking slot.

3. A door top sliding child safety lock mechanism in accordance with claim 1, wherein the interlock cut-out comprises a rectangular notch formed along the distal edge of the locking slot.

4. A door top sliding child safety lock mechanism in accordance with claim 3, wherein the interlock cut-out comprises a rectangular notch formed along the distal edge of the locking slot and a leading incline portion disposed towards the open end of the locking slot.

5. A door top sliding child safety lock mechanism in accordance with claim 1, wherein the lock plate further comprises an anti-walk feature formed along the distal edge of the locking slot, the anti-walk feature being a profile that biases the lock plate laterally towards the open end of the locking slot when pushed against the peg.

6. A door top sliding child safety lock mechanism in accordance with claim 5, wherein the anti-walk feature is a portion of the interlock cut-out.

7. A door top sliding child safety lock mechanism in accordance with claim 5, wherein the anti-walk feature is separate from the interlock cut-out.

8. A door top sliding child safety lock mechanism for mounting on a door assembly to resist opening of the door assembly by a child, the safety lock mechanism comprising:
a body slidably mountable on a door top of a door assembly comprising a door hingedly connected to a door frame, the door being rotatable relative to the door frame about a hinge axis, the door top extending between a frame-side face of the door and an open-side face of the door, the body comprising:
a channel section including a web extending between a first flange and a second flange, the second flange being disposed parallel to the first flange, the channel section configured so that the web can rest on the door top with the first flange depending from the web adjacent to the frame-side face of the door and the second flange depending from the web adjacent to the open-side face of the door, the frame-side and open side faces of the door defining a lateral direction parallel thereto; and
a lock plate extending perpendicularly from an outer face of the first flange, the lock plate configured to extend horizontally away from the frame-side face of the door when the body is mounted on the door top,
the lock plate defining a locking slot extending between an open end disposed along a first lateral edge of the lock plate to a closed end along a slot axis parallel to the frame-side face of the door;
the lock plate further defining an interlock cut-out formed along a distal edge, relative to the first flange, of the locking slot, wherein a first width W_{G} measured perpendicular to the slot axis at the interlock cut-out is greater than a second width W_{L} measured perpendicular to the slot axis in a region of the lock plate that is laterally intervening between the interlock cut-out and the open end of the locking slot; and
a peg configured to slide into the locking slot and fixedly mountable to a portion of the door frame adjacent to a frame-side edge of the door top to extend downward from the door frame; and
wherein, when the body is positioned on the door top of a door adjacent the door frame and the peg is fixedly mounted on the door frame with the peg aligned with the slot axis, the lock mechanism can move between an unlocked configuration and a locked configuration by sliding the body laterally on the door relative to the peg;
wherein, when the lock mechanism is in the unlocked configuration, the peg is disposed outside the locking slot of the lock plate, thereby allowing the body to rotate around the hinge axis away from the peg and allowing the door to rotate away from the door frame; and
wherein, when the lock mechanism is in the locked configuration, the peg is disposed within the locking slot of the lock plate, thereby restricting the body from rotating around the hinge axis away from the peg and restricting the door from rotating away from the door frame; and
wherein the lock mechanism can move between the locked configuration and an interlocked configuration by rotating the body relative to the peg around the hinge axis;
wherein, when the lock mechanism is in the locked configuration, the peg is not disposed within the interlock cut-out of the lock plate, thus allowing the body to slide laterally far enough to release the peg from the locking slot; and
wherein, when the lock mechanism is in the interlocked configuration, the peg is at least partially disposed within the interlock cut-out, thereby restricting the body from sliding laterally far enough to release the peg from the locking slot.

9. A door top sliding child safety lock mechanism in accordance with claim 8, wherein the lock mechanism cannot move directly from the unlocked configuration into the interlocked configuration.

10. A door top sliding child safety lock mechanism in accordance with claim 8, wherein the lock plate further comprises an anti-walk feature formed along the distal edge of the locking slot, the anti-walk feature being a profile that biases the lock plate laterally towards the open end of the locking slot when pushed against the peg.

11. A door top sliding child safety lock mechanism comprising:
a body slidably mountable on a top of a door, the body including a channel section and a locking plate;
the channel section including a web extending between a first flange and a second flange, the second flange being disposed parallel to the first flange; and
the lock plate extending perpendicularly from an outer face of the first flange and defining a locking slot extending between an open end disposed along a lateral edge of the lock plate to a closed end along a slot axis running parallel to the flanges; and
a peg mountable to a door frame and configured to slide through the open end of the locking slot and between the proximal and distal edges of the locking slot; and
wherein the lock plate further defines an anti-walk feature formed along one side of the locking slot, the anti-walk feature being a profile that biases the lock plate laterally towards the open end of the locking slot when pushed against the peg.

12. A door top sliding child safety lock mechanism in accordance with claim 11, wherein the anti-walk feature comprises a notch formed along a distal edge of the locking slot relative to the first flange, and wherein the distal edge of the notch slopes towards the first flange viewed in a direction towards the open end of the locking slot.

13. A door top sliding child safety lock mechanism in accordance with claim 11, wherein the lock plate further defines an interlock cut-out;
the interlock cut-out being a profile formed along a distal edge of the locking slot; and
wherein a first width W_{G} measured perpendicular to the slot axis at the interlock cut-out is greater than a second width W_{L} measured perpendicular to the slot axis in a region of the lock plate that is laterally intervening between the interlock cut-out and the open end of the locking slot.

14. A door top sliding child safety lock mechanism in accordance with claim 13, wherein the interlock cut-out comprises an arcuate notch formed along the distal edge of the locking slot.

15. A door top sliding child safety lock mechanism in accordance with claim 13, wherein the interlock cut-out comprises a rectangular notch formed along the distal edge of the locking slot.

16. A door top sliding child safety lock mechanism in accordance with claim 15, wherein the interlock cut-out comprises a rectangular notch formed along the distal edge of the locking slot and a leading incline portion disposed towards the open end of the locking slot.
